(19) United States
(12) Patent Application Publication
(10) Pub. No.: US 2013/0022793 A1
(43) Pub. Date: Jan. 24, 2013

(54) PEEL OFF CHILD PHOTO POSTER

(71) Applicants: Frank Kolachny, Philadelphia, PA (US); Margaret Murphy, Philadelphia, PA (US)

(72) Inventors: Frank Kolachny, Philadelphia, PA (US); Margaret Murphy, Philadelphia, PA (US)

(21) Appl. No.: 13/184,937

(22) Filed: Jul. 18, 2011

(51) Int. Cl. B32B 3/00; E04F 13/07

(52) U.S. Cl. 428/195.1; 156/71

(57) ABSTRACT

The present invention is a peel-off child photo poster of a child that includes a child photo with a front facing and a back facing that includes a life-sized, personalized action or still photo of a child playing a sport disposed on the front facing. The poster also includes a peel-off backing wherein the back facing is placed directly on the peel-off backing and is removable from the peel-off backing and a plurality of removable tabs that are utilized to secure the child photo to a vertical surface. The personalized action or still photo includes the child's name, age, team name and jersey number. The removable tabs are orientated in any suitable arrangement and number of removable tabs to secure the child photo to the vertical surface.

### TECHNICAL FIELD & BACKGROUND

Individuals often display posters of famous athletes in order to show admiration and/or support. Currently however, there are limited alternatives when it comes to personalizing large images for subsequently mounting posters of other persons such as a parent's child on an individual's wall.

The present invention generally relates to a poster. More specifically, the invention is a peel off child photo poster.

It is an object of the invention to provide a peel-off child photo poster for a user to display a life-sized photo of their child.

It is an object of the invention to provide a peel-off child photo poster to provide a user with a method for securing a peel-off child photo poster to a wall or other vertical surface.

What is really needed is a peel-off child photo poster for a user to display a life-sized photo of their child and a peel-off child photo poster to provide a user with a method for securing a peel-off child photo poster to a wall or other vertical surface.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a front perspective view of a peel-off child photo poster, in accordance with one embodiment of the present invention.

FIG. 1B illustrates a front perspective view of a plurality of removable tabs, in accordance with one embodiment of the present invention. FIG. 2 illustrates a flow chart of a method for securing a peel-off child photo poster to a wall or other vertical surface, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

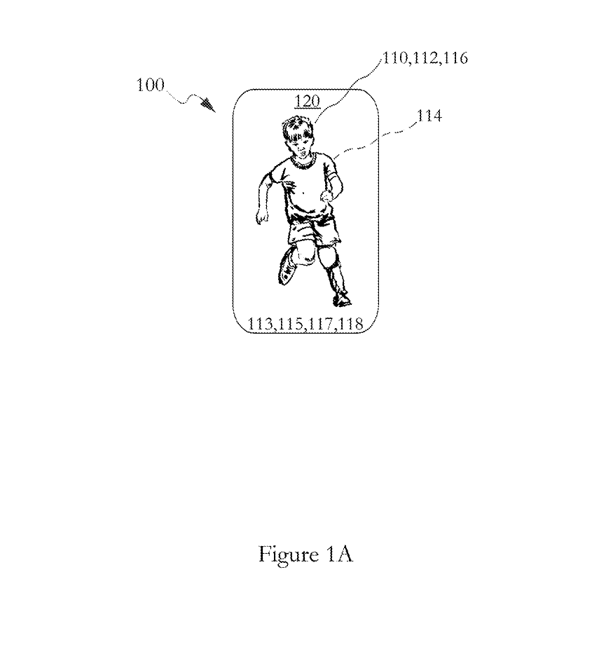

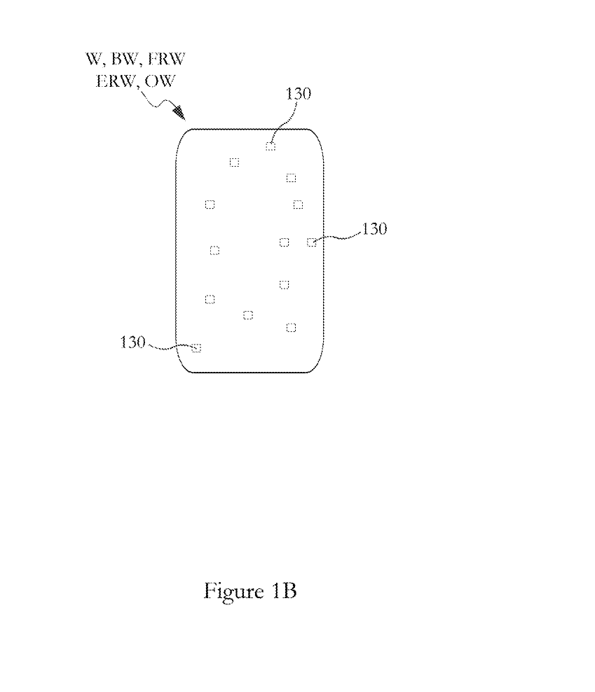

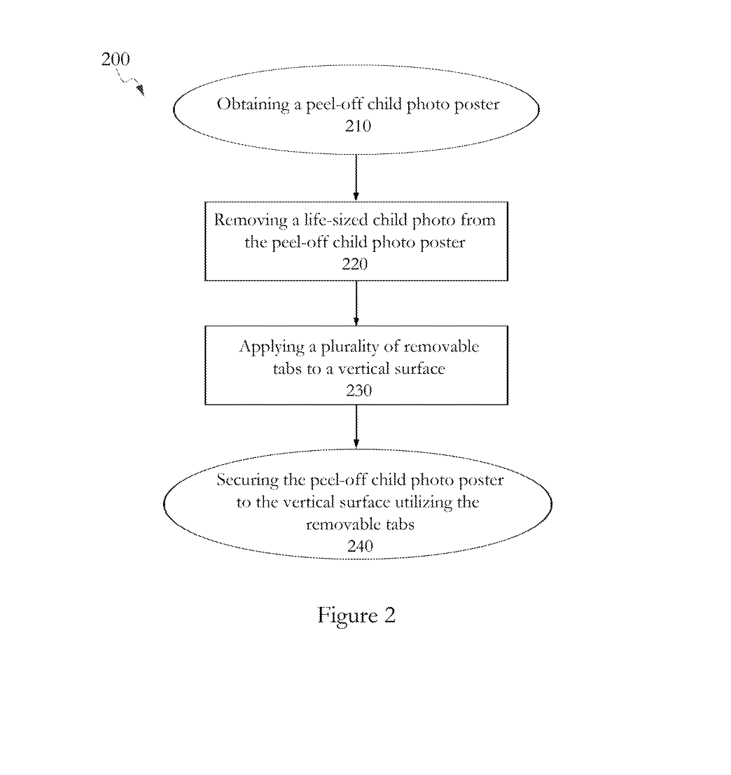

FIG. 1A illustrates a front perspective view of a peel-off child photo poster 100, in accordance with one embodiment of the present invention. The peel-off child poster 100 includes a child photo 110 and a peel-off backing 120.

The child photo 110 has a front facing 112 and a back facing 114. The child photo 110 has a typically life-sized, personalized action or still photo of a child playing a sport 116 that is disposed on the front facing 112, although other suitable child photos can be utilized. In contrast, the child photo 110 is similar to an action photo taken of a famous professional or college athlete such as Michael Jordan, O. J. Simpson or Hershel Walker. The child photo 110 includes the child's name 113, the child's age 115 and the child's team name 117 and/or jersey number 118. The back facing 114 is placed directly on the peel-off backing 120 and is relatively easily removable from the peel-off backing 120. The peel-off backing 120 is removably placed behind the child photo 110, allowing a user to relatively easily remove the child photo 110 from the peel-off backing 120. The peel-off backing 120 is large enough to accommodate the entire size of the life-sized child photo 110 and can be relatively easily picked-off the peel-off backing 120 to begin removal and separation from the peel-off backing 120.

FIG. 1B illustrates a front perspective view of a plurality of removable tabs 130, in accordance with one embodiment of the present invention. The removable tabs 130 are utilized to secure the child photo 110 to a wall W or other suitable vertical surface. The removable tabs 130 are orientated in any suitable arrangement and number of removable tabs 130 to secure the child photo 110 to the wall W. The removable tabs 130 are self-adhering and do not tear any peel-off child photo poster being secured and leave no residue on the wall W or suitable vertical surface. The wall W can be a bedroom wall BW, a family room wall FRW, an entertainment room wall ERW or an office wall OW.

FIG. 2 illustrates a flow chart of a method 200 for securing a peel-off child photo poster to a wall or other vertical surface, in accordance with one embodiment of the present invention. The method 200 includes obtaining a peel-off child photo poster 210, removing a life-sized child photo from the peel-off child photo poster 220, applying a plurality of removable tabs to a vertical surface 230 and securing the peel-off child photo poster to the vertical surface utilizing the removable tabs 240.

The peel-off child photo poster can be obtained 210 from any suitable provider of the peel-off child photo poster and includes the child's name, the child's age and the child's team name and/or jersey number. The life-sized child photo from the peel-off child photo poster is removed 220 by picking the peel-off the child photo off a peel-off backing and continuing to remove and separate the remainder of the child photo off the peel-off backing. The removable tabs are applied 230 in any suitable orientation on a vertical surface such as a wall to accommodate the peel-off child photo poster. The peel-off child photo poster is secured to the vertical surface utilizing the removable tabs 240 by pressing the peel-off child photo poster onto the removable tabs disposed on the vertical surface. The removable tabs are self-adhering, do not tear any poster being secured and leave no residue on the suitable vertical surface.

The peel-off child poster includes a life-sized, personalized action or still photograph of a child designed to be mounted directly onto any wall or suitable vertical surface. The peel-off child poster is relatively easy to use and employs a plurality of removable peel-off child poster tabs which allow the user to relatively easily relocate the peel-off child poster, preventing tears and unsightly residue on walls. In order to further enhance and personalize the peel-off child poster, the photo includes the name and age of the child, in addition to the team name and/or team jersey number of the child. The peel-off child poster is suitable for use with bedrooms, family rooms, entertainment rooms, offices and other suitable areas. Among those who will find the peel-off child poster to be a useful and exciting product are youth sports clubs, college and high school athletes, schools and sports equipment and apparel manufacturers.

The peel-off child poster features life-sized photographs equipped with a plurality of peel-off child poster tabs in order to provide effortless mounting and removal, as well as to prevent any damage to the surface of the wall or tearing of the poster. The peel-off child poster allows users to upload photos from their personal library to the peel-off child poster which are then manufactured and shipped directly to the user's home or business in a sturdy cardboard shipping container preventing crushing or loss of integrity.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A peel-off child photo poster of a child, comprising;
a child photo with a front facing and a back facing that includes a life-sized, personalized action or still photo of a child playing a sport disposed on said front facing; and
a peel-off backing wherein said back facing is placed directly on said peel-off backing and said child photo is removable from said peel-off backing.

2. The poster according to claim 1, wherein said personalized action or still photo includes said child's name.

3. The poster according to claim 1, wherein said personalized action or still photo includes said child's age.

4. The poster according to claim 1 wherein said personalized action or still photo includes said child's team name.

5. The poster according to claim 1, wherein said personalized action or still photo includes said child's jersey number.

6. A peel-off child photo poster of a child, comprising:
a child photo with a front facing and a back facing that includes a life-sized, personalized action or still photo of a child playing a sport disposed on said front facing;
a peel-off backing wherein said back facing is placed directly on said peel-off backing and said child photo is removable from said peel-off backing; and
a plurality of removable tabs that are utilized to secure said child photo to a vertical surface.

7. The poster according to claim 6, wherein said personalized action or still photo includes said child's name.

8. The poster according to claim 6, wherein said personalized action or still photo includes said child's age.

9. The poster according to claim 6, wherein said personalized action or still photo includes said child's team name.

10. The poster according to claim 6, wherein said personalized action or still photo includes said child's jersey number.

11. The poster according to claim 6, wherein said removable tabs are orientated in any suitable arrangement and number of removable tabs to secure said child photo to said vertical surface.

12. The poster according to claim 6, wherein said removable tabs are utilized to secure said back facing of child photo to said vertical surface.

13. The poster according to claim 12, wherein said vertical surface is a wall.

14. The poster according to claim 13, wherein said wall is a bedroom wall.

15. The poster according to claim 13, wherein said wall is a family room wall.

16. The poster according to claim 13, wherein said wall is an entertainment room wall.

17. The poster according to claim 13, wherein said wall is an office wall.

18. A method for securing a peel-off child photo poster to a wall or other vertical surface, comprising:
obtaining said peel-off child photo poster;
removing a life-sized child photo from said peel-off child photo poster;
applying a plurality of removable tabs to said vertical surface; and
securing said peel-off child photo poster to said vertical surface utilizing said removable tabs.

19. The method according to claim 18, wherein said peel-off child photo poster is removed by picking said life-sized child photo off said peel-off backing and continuing to remove and separate said child photo off said peel-off backing.

20. The method according to claim 18, wherein said removable tabs are self-adhering, do not tear any poster being secured by said removable tabs and leave no residue on said suitable vertical surface.
